(19) United States
(12) Patent Application Publication
(10) Pub. No.: US 2010/0300787 A1
(43) Pub. Date: Dec. 2, 2010

(54) HOVER DODGEM

(76) Inventor: Fergus Johnathan Ardern, Norfolk (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/744,948

(22) PCT Filed: Nov. 25, 2008
(86) PCT No.: PCT/GB08/51111

§ 371 Date: May 27, 2010

(30) Foreign Application Priority Data
Nov. 30, 2007 (GB) 0723424.8

(51) Int. Cl. B60V 1/11

(52) U.S. Cl. 180/117

(57) ABSTRACT

A hover dodgem (1) comprising a hovercraft having seating (5) for at least one adult human and a battery-powered lift' and thrust fan, sufficient to lift the dodgem when carrying an adult human. Preferred dodgems have rotatable thrust air exit paths, are circular, or have thrust air exit paths angled towards the ground. Wireless control means allow remote control of the dodgems.

### FIELD OF THE INVENTION

The invention relates to vehicles for use in an entertainment context, especially where multiple such vehicles are employed and in which collisions between such vehicles are to be expected, or even intended.

### PRIOR ART KNOWN TO THE APPLICANT

Dodgem cars or more briefly, “dodgems”, are known in an entertainment context and consist of small electric cars drawing their power from an overhead power supply grid to enable users to entertain themselves in a controlled environment by bumping the cars into each other, or alternatively dodging each other to avoid such collisions. Dodgem cars are also known as “bumper cars”, for this reason. The dodgems are used on a specifically-designed track, or floor. Steering of the cars is effected by use of a steering wheel, which allows the driven wheels to be turned through 180° or more, thereby providing a means to reverse the cars.

It is reported that in the early 1960's, a fairground attraction called “Flying Saucers” was attempted in which small “cars” were suspended on a cushion of air produced by blowing a blast of air though a specially-created perforated operating surface thereby causing the saucers to float just above the floor. It is also reported that movement of the saucers was effected by a user shifting their weight from side to side. Despite the attraction of such a ride, technical problems reportedly prevented success.

### SUMMARY OF THE INVENTION

Accordingly, in a first aspect, the invention provides a hover dodgem comprising a hovercraft having: seating for at least one adult human; and battery-powered fan means to provide thrust and lift, sufficient to lift the dodgem when carrying an adult human.

In a second aspect, the invention also provides a hover dodgem comprising a hovercraft having: seating for at least one adult human; fan means to provide thrust and lift, sufficient to lift the dodgem when carrying an adult human; wherein said hovercraft is substantially circular, thereby causing the transfer of angular momentum between like dodgems to be primarily effected by frictional forces between dodgems.

In a first preferred subsidiary aspect, the hover dodgem further comprises rotatable vanes configured to deflect air leaving an air exit duct, thereby enabling a user to steer the dodgem by rotation of said vanes. More preferably, lift and thrust are provided by a single fan.

In a second preferred subsidiary aspect, the hover dodgem comprises a thrust fan within an air exit duct, said duct being configured to be rotatable by a user, in use, thereby causing the air exit path to be rotatable about an axis substantially perpendicular to the ground, in use, so enabling a user to steer the dodgem by rotation of the air exit duct, without the use of a rudder.

When separate fans for thrust and lift are provided, it is particularly preferred that the hover dodgem has a reversible thrust fan, thereby enabling a user to reverse the thrust direction.

In any aspect of the invention it is preferred that the hover dodgem is substantially circular, thereby causing the transfer of angular momentum between like dodgems to be primarily effected by frictional forces between dodgems.

Also in any aspect of the invention, it is preferred that the hover dodgem a thrust fan with an air exit path angled towards the ground, in use.

Again in any aspect of the invention, it is preferred that the hover dodgem further comprises wireless control means to allow remote control of said dodgem.

Also included within the scope of the invention is a hover dodgem substantially as described herein, with reference to and as illustrated by any appropriate combination of the accompanying drawings.

### BRIEF DESCRIPTION OF THE DRAWINGS

The invention will be described with reference to the accompanying drawings in which:

FIGS. 1 and 2 illustrate, in perspective view, a hover dodgem;

FIG. 3 illustrates, in perspective view the underside of a hover dodgem;

FIGS. 4 and 5 illustrate in perspective cross-sectional view a hover dodgem;

FIG. 6 is a side elevation view of a hover dodgem;

FIG. 7 is a schematic plan view of a hover dodgem;

FIG. 8 is a perspective view of an embodiment of a hover dodgem;

FIGS. 9 and 10 are schematic plan views of a van arrangement;

FIG. 11 is a perspective view of a hover dodgem; and

FIG. 12 is a partial cut-away perspective view of a hover dodgem.

### DESCRIPTION OF PREFERRED EMBODIMENTS

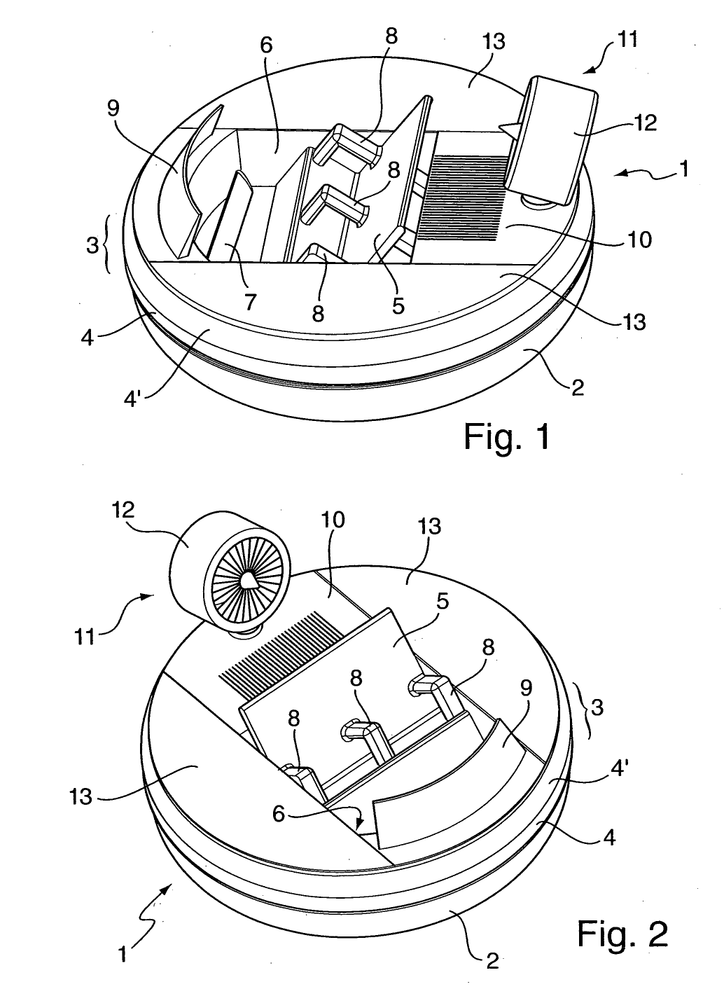

FIGS. 1 and 2 illustrate, in perspective view, a hover dodgem, generally indicated by 1, according to the present invention. The dodgem is of generally circular shape. A design of this shape removes any corners from the outside edge of the dodgem, and therefore improves the safety of the occupants and other people in the vicinity; this is especially important in the context of the dodgem being used in a multi-dodgem entertainment venue where collisions between dodgems are to be expected, if not positively encouraged. Secondly, the circular shape assists in providing a predicable separation angle between like dodgems after a collision, enabling users to use their skills and readily develop strategies for multi-dodgem games. Thirdly, a circular shape ensures that angular momentum transfer between like dodgems is primarily effected by frictional forces between dodgems, thereby allowing the degree of spin imparted from one dodgem to another to be limited—again, safety considerations are paramount. By comparison to wheeled dodgem cars, once a hover dodgem is spun, it is more difficult to stop the spinning, and this feature therefore has safety advantages. If the components of the dodgem are arranged so that the centre of mass of the dodgem lies at or close to the geometric centre of the circular dodgem, then collisions between (non-spinning) dodgems result primarily in transfer of linear momentum, rather than creating spin. As the mass of occupants cannot be pre-determined, positioning of the seat, or seats (in the case of a two-person dodgem) at or close to the geometric centre of the dodgem is particularly beneficial if post-collision spin is to be controlled; in this way, the overall location of the centre of mass is largely unaltered in the face of different weight occupants. In order to control the amount of angular momentum transferable, the frictional characteristics of the fender region 3 may be manipulated. The use of low friction materials (or even the application of a suitable lubricant to the fender) allows the angular momentum transfer to be reduced.

At the bottom edge of the dodgem is a flexible skirt 2 under which air, in use, escapes to provide the air cushion on which the dodgem floats. Above the skirt 2 is a bumper region 3 comprising two bumpers, or fenders, 4, constructed of a plastics material such as vinyl or neoprene and so shaped as to form a resiliently-deformable fender.

Located approximately centrally in the dodgem, is a pair of seats 5 set low down in a recessed portion 6 in order to keep the centre of gravity of the dodgem as low as possible. The seats 5 are angled away from the normal direction of travel of the dodgem and a foot-bracing surface 7 is provided to allow the user, in use, to assume a braced position on the angled seat 5 and foot-bracing surface 7. The location of the seat, the rearward-sloping angle, and the provision of a foot-bracing surface provides not only a low centre of gravity, but also provides additional support to the user's body in the event of the expected collisions encountered in typical dodgem entertainment scenario. The seat 5 is provided with armrests 8 adjacent each seating position.

At the front of the dodgem is provided a windshield 9 of transparent material such as acrylic glass.

Behind the seat 5 is located an air intake grille 10 through which air is sucked into the unit by the fan or fans (not illustrated).

Located at the rear of the dodgem is a fan assembly 11 comprising a fan duct 12 surrounding an electric thrust fan (not illustrated) to provide forward and reverse motive power for the dodgem.

Located either side of the seat 5 are removable covers 13 giving access to battery storage compartments within the dodgem (not illustrated).

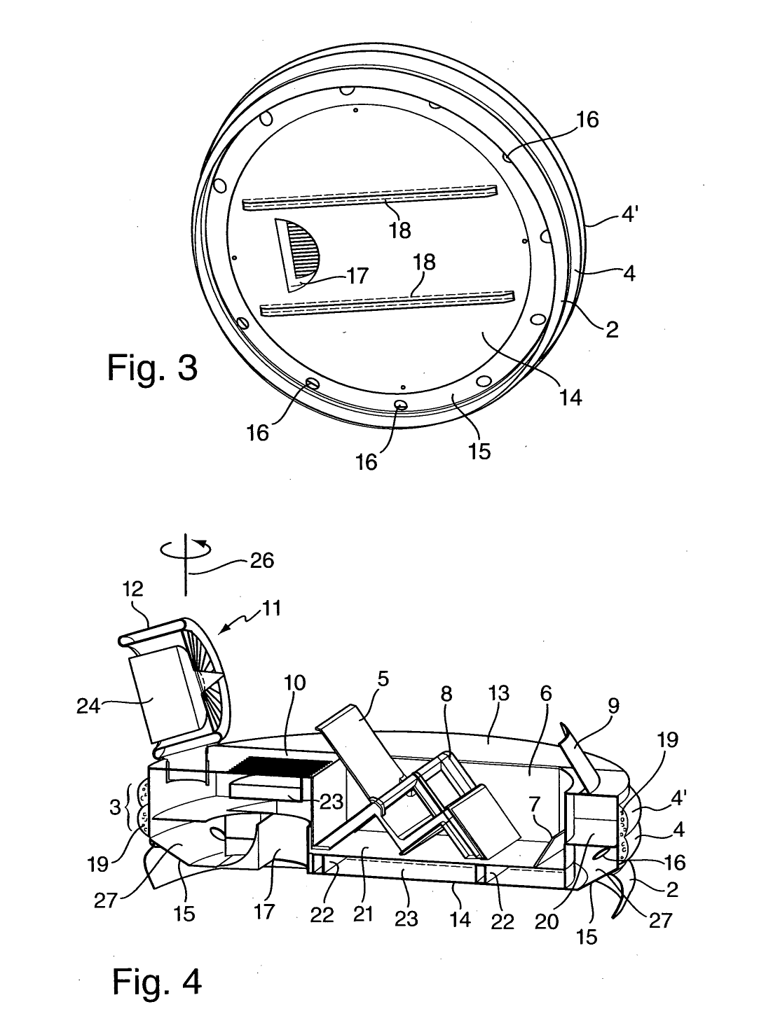

FIG. 3 illustrates, again in perspective view, the underside of a hover dodgem according to the present invention. The skirt 2 surrounds a base plate 14 having a upwardly-sloping peripheral region 15 around which are disposed a number of peripheral air outlet ducts 16 to assist in even inflation of the skirt 2. Located towards the rear of the dodgem, and on an axial mid-line, is a main duct 17 of semi-circular form through which air is pushed by a lift fan (not illustrated) again to inflate the skirt 2 and to provide overall lift.

Also mounted on the base plate 14 are two skids 18 to raise the base plate 14 from the ground whilst the lift fan is not operating, thereby preventing blockage of the main air duct 17.

FIG. 4 is a perspective cross-sectional view of a hover dodgem according to the present invention. The figure illustrates that the bumpers 4 and 4′, in the bumper region 3 of the dodgem are, in this embodiment, filled with a closed cell foam 19 to increase buoyancy of the dodgem. Located around the periphery of the dodgem is a further cavity 20 that may also be filled with closed cell foam, thus creating a buoyancy chamber and increasing buoyancy still further. The floor of the hover dodgem is of a sandwich construction composed of the base plate 14 and a floor plate 21 separated by transverse separating members 22, the space between them 23 again being filled with a closed cell foam to improve buoyancy. The use of closed cell foam in any or preferably all of these cavities increases the safety of the device—especially important in the entertainment context in which it is intended for use—both in terms of increased buoyancy, especially in the face of any physical damage to the structure of the dodgem, thereby allowing the dodgem to be used on water, and also by providing additional impact resistance.

Two fans are provided in this embodiment: a thrust fan 24 located within the thrust duct 12 of the thrust assembly 11, and a lift fan 25 located below the air intake grille 10.

Batteries, or electrical fuel cells, located in battery compartments 30 within the hover dodgem, electrically power the thrust fan 24. The use of electrically-powered, and especially self-contained battery power for the fans leads to a number of advantages particularly important in the context of use of a hover dodgem. Firstly, in contrast to petrol-powered fans, no liquid fuel need be carried in the dodgem, thereby greatly improving safety of the device, which is particularly important given that its context of use will be to be driven by non-qualified members of the public with little or no training, with a high likelihood, or even expectation, of collision between like vehicles. Secondly, the use of an electrically powered fan, allows the provision of controls to enable a user, in use, to reverse the direction of the thrust fan, enabling both forward and reverse thrust and thereby allowing the vehicle to be steered more accurately, and to have a degree of braking facility. In traditional hovercraft design, braking is usually accomplished by the use of negative pitch of the craft, or alternatively by changing the direction of the craft by 180° and using normal thrust. Thirdly, by use of electrically-powered fans, wireless control means may be provided within the dodgem, to allow an external operator to control the operation of the fan or fans, for example to remove power from the fans in the event of emergency or accident, or when it is required to prevent the user from using the dodgem any further.

To effect steering, the whole fan assembly 11 is rotatable about an axis 26 generally perpendicular to the base plate 14, i.e. generally perpendicular to the ground surface over which the dodgem is intended to travel. It is conventional in hovercraft design, that any thrust fan is statically mounted and that steering is provided by means of externally-mounted rudders (in the form of vanes or flaps) behind the fan, and which may be angled by a user to direct the air stream from the thrust fan in different directions. The provision of such an alternative steering facility removes the need to have external flaps or vanes (i.e. mounted behind a fan or fan duct) which would otherwise pose a hazard to users from impact against the relatively sharp edges of the flaps. Again, the use of electrically-driven thrust fans, enables them to be mounted in a rotatable fan assembly such as that illustrated in FIG. 4. The relatively large weight of internal combustion engine-driven fans, and the need to pipe fuel to them, would prevent such a steering mechanism in e.g. a petrol-driven hovercraft.

Lift fan 25 draws air through the air inlet grille 10 directing it generally downwards where the air flow is split into two portions. One portion flows through the main lift duct 17 whilst another portion is directed into a peripheral duct 27 from where it leaves via the peripheral air outlet ducts 16.

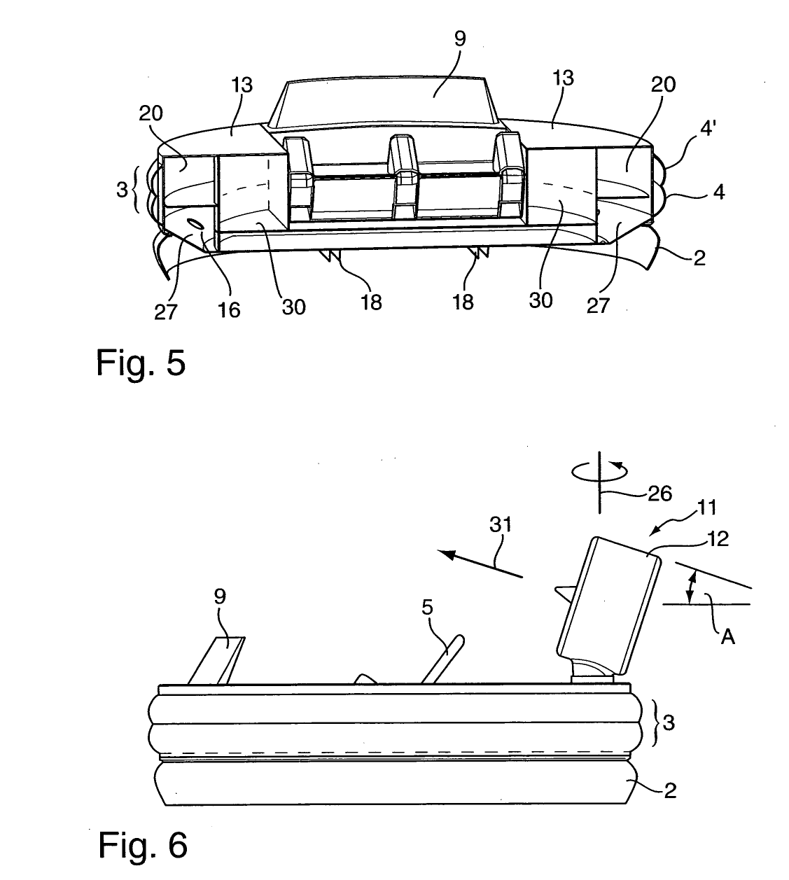

FIG. 5 illustrates, again in perspective cross-sectional view, a hover dodgem according to the present invention. FIG. 5 illustrates further the configuration of the buoyancy chamber 20, filled with closed cell foam, and the peripheral duct 27 and peripheral air ducts 16. Also illustrated in FIG. 5 are battery storage compartments 30 located either side of the central recessed portion 6.

FIG. 6 illustrates a side elevation view of a hover dodgem of the present invention. The figure illustrates specific and preferred embodiments of the thrust fan assembly 11. Firstly, it is illustrated that the fan assembly may be rotated by a user about an axis 26 perpendicular to the base of the hover dodgem, thereby enabling the unit to be steered without the use of external flap or vanes. Secondly, it illustrates that the thrust duct 12 is configured to reject a stream of air at an angle A relative to the ground. This has a number of distinct advantages: firstly, directing the thrust jet towards the ground improves the thrust characteristics of the thrust fan; secondly, and again this is particularly important in the context of an entertainment hover dodgem, the air jet is not pointing directly towards other users, who may be located immediately behind the hover dodgem during a race or dodgem session; this reduces the likelihood of any foreign bodies being ejected by the fan into the faces of adjacent users. Furthermore, when the fan direction is reversed, producing a reverse thrust of air, illustrated by arrow 31 the air jet passes over the heads of users sitting in the seat 5 rather than being directed directly at them; again, this additional safety feature is particularly important in the context on an entertainment hover dodgem.

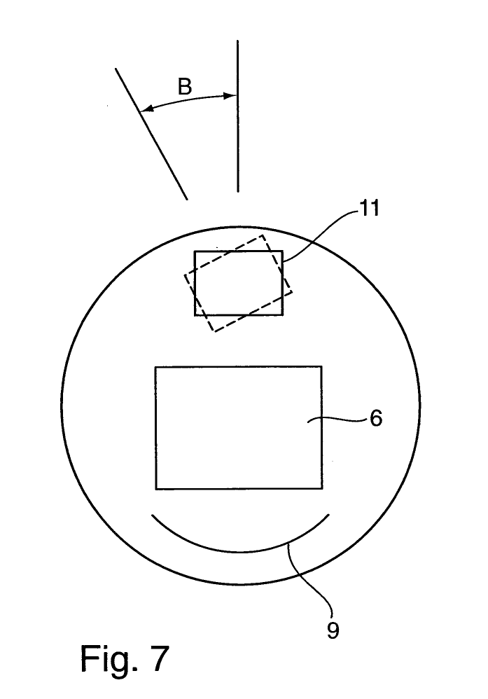

FIG. 7 is a schematic plan view of a hover dodgem illustrating the rotation of a fan assembly 11 through an angle B between a first position (illustrated by the solid line) and a second position (illustrated by the dashed line). Rotation of the fan assembly in this fashion effects steering of the dodgem. In particularly preferred embodiments, the swivelling angle B is limited to +/−90° to prevent injury to passengers located within the recessed portion 6 from the air jet produced by the thrust fan. In even more preferred embodiments, where it is required to prevent a user putting a dodgem into a rapid spin, the swivelling angle B is limited to +/−45°, or even +/−30°.

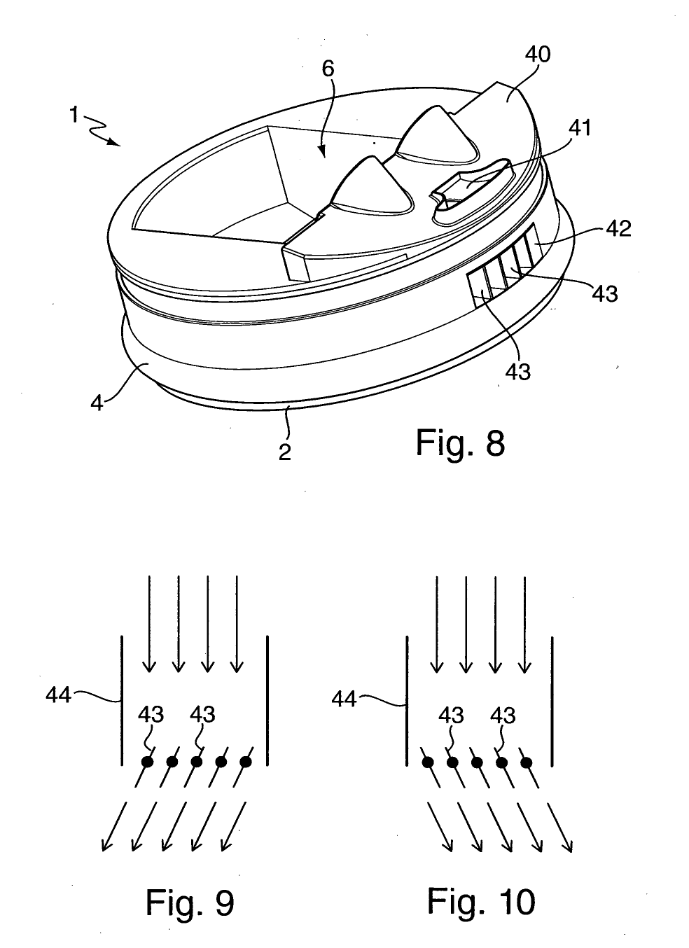

FIG. 8 illustrates, in perspective view, a further embodiment of a hover dodgem 1 of the present invention. In this embodiment, thrust and lift are provided by a single fan (not visible in FIG. 8) located within a fan compartment located under a cover 40. The cover 40 is provided with an air intake port 41, protected by an air intake grille (not illustrated, for clarity). The grille and fan are so positioned to prevent a user being able to touch the rotating blades of the fan—again, safety is paramount in the design. A recessed portion 6 is again provided in which seating for a user is mounted. At the rear of the hover dodgem is located the outlet 42 of an air outlet duct, within which are located a number of rotatable vanes 43 to allow the direction of the emerging air stream to be varied by rotation of the vanes about a generally vertical axis. FIGS. 9 and 10 illustrate, in schematic plan view, the arrangement of vanes 43 located within an air outlet duct 44. Viewed from above, positioning of the vanes 43 as illustrated in FIG. 9 would provide an air jet to steer the vehicle towards the left, and positioning of the vanes as illustrated in FIG. 10 would provide an air jet to steer the vehicle towards the right.

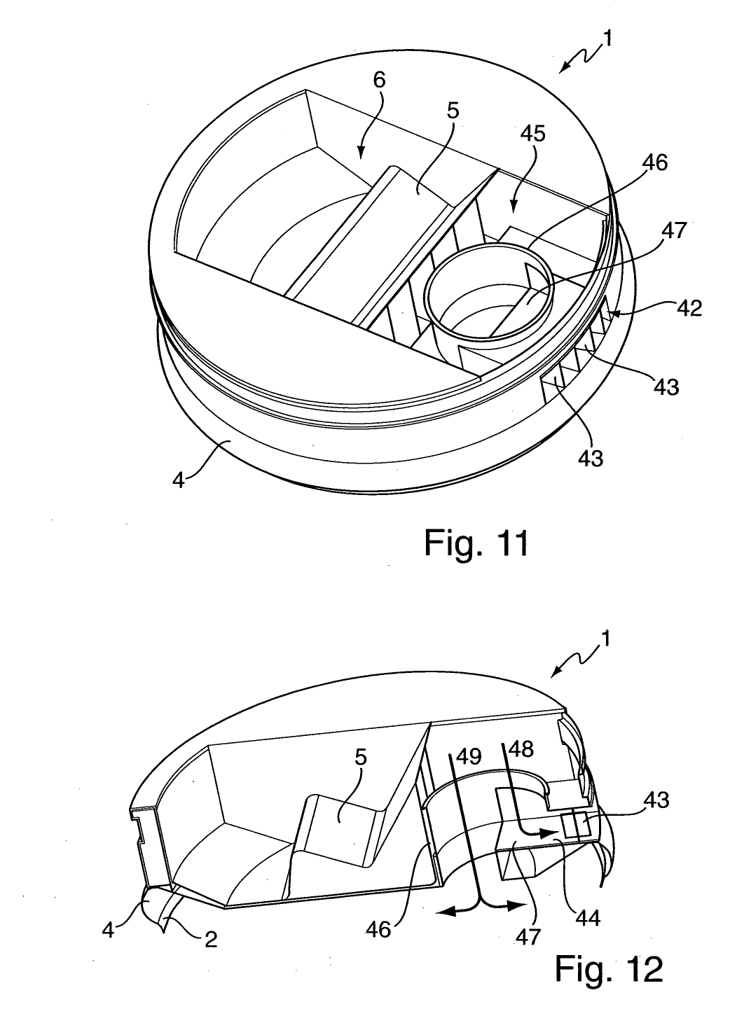

FIG. 11 illustrates the embodiment of FIG. 10, again in perspective view, with the cover 40 removed. Located within a fan compartment 45 is a fan inlet duct 46, within or on top of which is located the combined thrust and lift fan (not illustrated, for clarity). A baffle 47 within the duct serves to split the flow of air from the fan such that one stream passes through the air outlet duct 44, and a second stream passes into the cavity underneath the hover dodgem to inflate the skirt 2.

FIG. 12 illustrates the embodiment of FIG. 11 in a partial cut-away perspective view. The figure illustrates the first stream of air (by arrow 48), diverted by the baffle 47 into the air outlet (thrust) duct 44 and the second stream of air (by arrow 49) directed to the cavity below the hover dodgem to inflate the skirt 2. Again, for clarity, the fan is not illustrated in FIG. 12, but would be positioned in, or above, the fan inlet duct 46. It is especially preferred that the vanes 34 are entirely contained within the air outlet duct 44, to prevent sharp edges protruding from the outside edge of the dodgem, thereby increasing the safety of the device.

In yet further alternative embodiments, a stream of air from the combined lift and thrust fan may be directed, via moveable baffles, to nozzles located on the outside of the dodgem and oriented so as to provide sideways thrust to the vehicle. In this way, control of the baffles by a user thereby gives an alternative means of steering the vehicle.

In any embodiment of the invention, in order to allow the hover dodgems to be readily transported between venues, it is preferred that they have a width dimension of less than 2.5m, preferable no more than 2.3m. In order to facilitate moving the dodgems by hand, castors or wheels may be provided on the base plate. Also, it is preferable that the maximum weight of the dodgem should not exceed 250 kg, and preferably no more than 200 kg, or even no more than 150 kg.

In order to provide sufficient power to the electrically-driven fan, or fans, batteries, such as rechargeable Lithium batteries may be used to power the fans through an inverter. Suitable means providing enough power to lift the dodgem, and provide a useful operating period between charges include the use of 160 Ah lithium batteries and a 3 kW inverter.

1. A hover dodgem comprising a hovercraft having:
seating for at least one adult human; and
battery-powered fan means to provide thrust and lift, sufficient to lift the dodgem when carrying an adult human.

2. A hover dodgem comprising a hovercraft having:
seating for at least one adult human;
fan means to provide thrust and lift, sufficient to lift the dodgem when carrying an adult human; wherein
said hovercraft is substantially circular, thereby causing the transfer of angular momentum between like dodgems to be primarily effected by factional forces between dodgems.

3. A hover dodgem according to claim 1 comprising rotatable vanes configured to deflect air leaving an air exit duct, thereby enabling a user to steer the dodgem by rotation of said vanes.

4. A hover dodgem according to claim 3 wherein lift and thrust are provided by a single fan.

5. A hover dodgem according to claim 1 comprising a thrust fan within an air exit duct, said duct being configured to be rotatable by a user, in use, thereby causing the air exit path to be rotatable about an axis substantially perpendicular to the ground, in use, so enabling a user to steer the dodgem by rotation of the air exit duct, without the use of a rudder.

6. A hover dodgem according to claim 1, having a reversible thrust fan, thereby enabling a user to reverse the thrust direction.

7. A hover dodgem according to claim 1 wherein said hovercraft is substantially circular, thereby causing the transfer of angular momentum between like dodgems to be primarily effected by frictional forces between dodgems.

8. A hover dodgem according to claim 1 claim having a thrust fan with an air exit path angled towards the ground, in use.

9. A hover dodgem according to claim 1 claim further comprising wireless control means to allow remote control of said dodgem.

10. (canceled)
